(19) United States
(12) Patent Application Publication
(10) Pub. No.: US 2015/0035237 A1
(43) Pub. Date: Feb. 5, 2015

(54) SEALING STRUCTURE

(71) Applicant: NOK CORPORATION, Tokyo (JP)

(72) Inventors: Hikaru Tadano, Kitaibaraki-shi (JP); Hiroaki Monma, Kitaibaraki-shi (JP)

(21) Appl. No.: 14/379,928

(22) PCT Filed: Nov. 22, 2012
(86) PCT No.: PCT/JP2012/080330

§ 371 Date: Aug. 20, 2014

(30) Foreign Application Priority Data
Feb. 24, 2012 (JP) 2012-038641

(51) Int. Cl. F02M 61/14; F16J 15/10; F02M 61/16

(52) U.S. Cl. CPC F02M 61/14; F02M 61/16; F16J 15/10
USPC 277/591

(57) ABSTRACT

A sealing structure which is able to reduce an inserting load, while enhancing a sealing performance is provided. The sealing structure includes an annular groove (211) having a step on its groove bottom, and is provided with a primary annular groove (211a) disposed at one side of the step, and a secondary annular groove (211b) disposed at another side of the step, and a gasket (400) is disposed so as to be filled into the primary annular groove (211a), and a gap (D2) between an injector and a mounting hole at a boundary section between the primary annular groove (211a) and the secondary annular groove (211b) is larger than a minute gap (D1) at an opposite side of the secondary annular groove (211b) intervened by the primary annular groove (211a).

### CROSS-REFERENCE TO RELATED APPLICATIONS

This application is a National Stage of International Application No. PCT/JP2012/080330, filed Nov. 22, 2012, which claims priority to Japanese Patent Application No. 2012-038641, filed Feb. 24, 2012. The entire disclosures of each of the above applications are incorporated herein by reference.

### FIELD

The present disclosure relates to a sealing structure to seal an annular gap between an injector and a housing.

### BACKGROUND

In a mounting portion of an injector to a cylinder head, an annular gasket which seals an annular gap between the injector and a mounting hole is provided. In such a gasket, there has been known a technique in which the volume of the gasket, when it is in a state where no external force is acting thereon, is made larger than the volume of a space in which the gasket is to be fitted, so that its sealing performance is improved by filling the gasket into an annular groove in which the gasket is to be fitted (refer to a first patent document).

In such a technique, however, when an injector with the gasket fitted thereon is being inserted into a mounting hole, a large load may be applied, and thus the gasket may be exceptionally deformed or damaged. In addition, it is considered that with such a technique, manual insertion may be difficult.

### PRIOR ART REFERENCES

### Patent Documents

First Patent Document: Japanese patent application laid-open No. 2002-81548

### SUMMARY

### Problem to be Solved by the Disclosure

The object of the present disclosure is to provide a sealing structure that is able to reduce an inserting load, while enhancing a sealing performance.

### Means for Solving the Problem

In order to solve the above-mentioned problem, the present disclosure adopts the following means.

That is, a sealing structure comprising: an injector; a housing having a mounting hole in which the injector is mounted; and an annular gasket being fitted in an annular groove formed in an outer periphery of the injector to seal an annular gap between the injector and the mounting hole; wherein the annular groove has a step on its groove bottom; the annular groove comprises: a primary annular groove disposed at one side of the step; and a secondary annular groove disposed at another side of the step; the gasket is disposed so that it is filled into the primary annular groove; and a gap between the injector and the mounting hole at a boundary section between the primary annular groove and the secondary annular groove is larger than a minute gap at an opposite side of the secondary annular groove intervened by the primary annular groove.

According to the present disclosure, because the gasket is filled into the primary annular groove, it becomes possible to enhance a sealing performance. In addition, because the secondary annular groove is provided, a part of the gasket filled into the primary annular groove can protrude into the secondary annular groove. For that reason, it is possible to reduce an inserting load at the time of inserting the injector with the gasket fitted thereon into the mounting hole. Further, the gap between the injector and the mounting hole at the boundary section between the primary annular groove and the secondary annular groove is larger than the minute gap at the opposite side of the secondary annular groove intervened by the primary annular groove. Hence, it becomes possible to cause a part of the gasket to protrude to the secondary annular groove side in a more reliable manner.

It is further characterized in that the following relation is satisfied: S1<S3<(S1+S2) where S1 is an area of a cross section of an annular space formed by the primary annular groove and a surface of the mounting hole intersected by a plane including an axis of the annular space, S2 is an area of a cross section of an annular space formed by the secondary annular groove and the surface of the mounting hole intersected by a plane including an axis of the annular space, S3 is an area of a cross section of the gasket intersected by a plane including an axis of the gasket when the gasket is in a state of not being subjected to any external force.

According to this, the gasket can be filled into the primary annular groove, while the gasket does not completely fill the secondary annular groove. For that reason, it is possible to suppress the gasket from protruding into the outside of the annular groove. In addition, along with this, it is also possible to suppress the inserting load.

It is preferable that the secondary annular groove be disposed at a combustion chamber side with respect to the primary annular groove.

According to this, when the injector with the gasket fitted thereon is inserted into the mounting hole, frictional resistance against the gasket acts on the opposite side of the combustion chamber, thus the gasket can be filled into the primary annular groove side in a more reliable manner. In addition, a portion of the gasket which has been filled into the secondary annular groove side is subjected to the pressure of a combustion gas, thus the filled state of the gasket with respect to the primary annular groove can be maintained, thereby making it possible to enhance the sealing performance thereof. Here, note that even if the gasket has been deformed due to creep over time, the gasket can stably maintain its filled state with respect to the primary annular groove by receiving the pressure of the combustion gas and the durability thereof can also be improved.

It is preferable that a shape of the cross section of the gasket intersected by the plane including the axis of the gasket when the gasket is in a state of not being subjected to any external force is rectangular.

Here, it is preferable that the primary annular groove has an annular protrusion portion formed on its groove bottom in a vicinity of a center in an axial direction thereof.

As a result of this, the contact pressure of the gasket with respect to the mounting hole can be partially made high, thus making it possible to enhance the sealing performance.

Here, note that the above-mentioned respective configurations can be combined with one another wherever possible.

### Effect of the Disclosure

As explained above, according to the present disclosure, it is possible to reduce the inserting load, while enhancing the sealing performance.

### DRAWINGS

FIG. 1 is a schematic cross sectional view showing a sealing structure according to an embodiment of the present disclosure.

FIG. 2 is a partially broken cross sectional view of a gasket according to the embodiment of the present disclosure.

FIGS. 3A and 3B are schematic cross sectional views of a sealing structure according to a first embodiment of the present disclosure.

FIGS. 4A and 4B are schematic cross sectional views of a sealing structure according to a second embodiment of the present disclosure.

FIGS. 5A and 5B are schematic cross sectional views of a sealing structure according to a third embodiment of the present disclosure.

FIGS. 6A and 6B are schematic cross sectional views of a sealing structure according to a fourth embodiment of the present disclosure.

FIGS. 7A and 7B are schematic cross sectional views of a sealing structure according to a fifth embodiment of the present disclosure.

FIGS. 8A and 8B are schematic cross sectional views of a sealing structure according to a sixth embodiment of the present disclosure.

### DETAILED DESCRIPTION

Hereinafter, modes for carrying out the present disclosure will be exemplarily described in detail based on embodiments thereof with reference to the attached drawings. However, the dimensions, materials, shapes, relative arrangements and so on of component parts described in the embodiments are not intended to limit the scope of the present disclosure to these alone in particular as long as there are no specific descriptions.

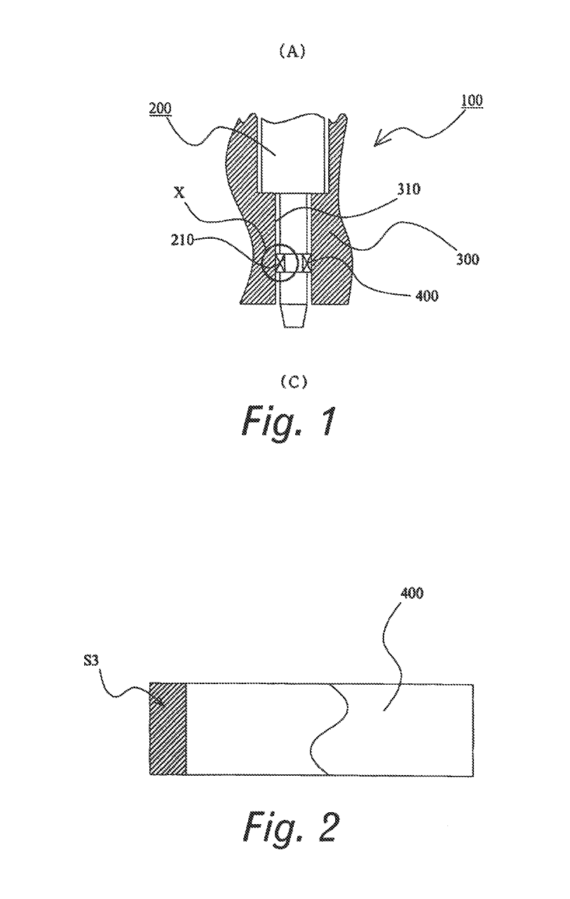

Referring to FIGS. 1 and 2, a sealing structure according to an embodiment of the present disclosure will be explained. The sealing structure 100 according to this embodiment is composed of an injector 200, a housing 300 having a mounting hole 310 in which the injector 200 is mounted, and a gasket 400. Here, note that in FIG. 1, with respect to the injector 200, only the vicinity of a tip end thereof which constitutes the sealing structure is shown. In addition, the housing 300 corresponds to a cylinder head of an engine, wherein only a portion of the housing 300 which constitutes the sealing structure is shown.

The gasket 400 is an annular member composed of PTFE (tetrafluoroethylene resin). The gasket 400 is also a member having a cylindrical shape, wherein the shape of a cross section thereof intersected by a plane including its axis is a rectangle when the gasket 400 is in a state of not being subjected to any external force (refer to FIG. 2). This gasket 400 is fitted in an annular groove 210 formed in an outer periphery of the injector 200, and seals an annular gap between the injector 200 and the mounting hole 310.

### First Embodiment

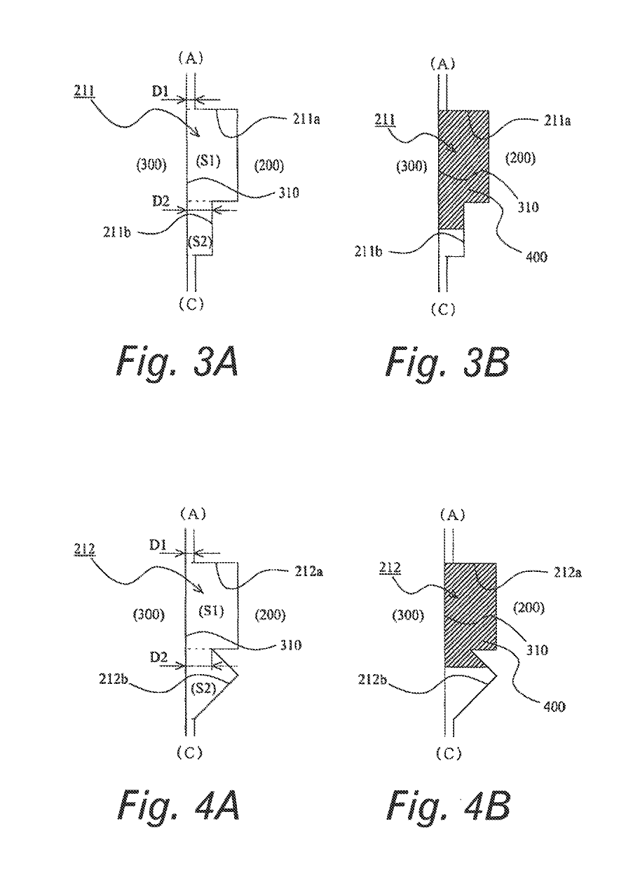

Referring to FIGS. 3A and 3B, a sealing structure according to a first embodiment of the present disclosure will be explained. FIGS. 3A and 3B are schematic cross sectional views of the sealing structure according to the first embodiment of the present disclosure, and correspond to enlarged views of a portion X in FIG. 1. Here, note that FIG. 3A is a view with a gasket 400 omitted, and FIG. 3B is a view with the gasket 400 illustrated.

In this embodiment, an annular groove 211 formed on the outer periphery of an injector 200 has a step on its groove bottom, and is composed of a primary annular groove 211a disposed at one side of this step and a secondary annular groove 211b disposed at the other side thereof. Here, note that the step is such that its diameter becomes larger from an atmospheric air side (A) to a combustion chamber side (C). The groove bottoms of the primary annular groove 211a and the secondary annular groove 211b are each composed of a cylindrical surface. The primary annular groove 211a is disposed at the atmospheric air side (A), and the secondary annular groove 211b is disposed at the combustion chamber side (C). Then, it is configured such that a gap D2 between the injector 200 and the mounting hole 310 at a boundary section between the primary annular groove 211a and the secondary annular groove 211b is larger than a minute gap D1 at the opposite side of the secondary annular groove 211b intervened by the primary annular groove 211a. Here, note that the above-mentioned gap D2 is smaller than a distance between the groove bottom of the primary annular groove 211a and the mounting hole 310.

In addition, in this embodiment, with respect to areas S1, S2 shown in FIG. 3A and an area S3 shown in FIG. 2, it is configured such that these areas satisfy the relation S1<S3<(S1+S2). Here, the area S1 is an area of a cross section of an annular space formed by the primary annular groove 211a and a surface of the mounting hole 310 intersected by a plane including an axis of the annular space. And, the area S2 is an area of a cross section of an annular space formed by the secondary annular groove 211b and the surface of the mounting hole 310 intersected by a plane including an axis of the annular space. Moreover, the area S3 is an area of a cross section of the gasket 400 intersected by a plane including its axis when gasket 400 is in a state of not being subjected to any external force.

Then, when inserting the injector 200 into the housing 300, the injector 200 is fitted into the mounting hole 310 in a direction from the atmospheric air side (A) toward the combustion chamber side (C) with the gasket 400 being fitted into the annular groove 211 of the injector 200. As a result of this, the gasket 400, which has a rectangular cross section when it is in a state of not being subjected to any external force, receives a force towards inside from an inner peripheral surface of the mounting hole 310 and deforms to conform with the shape of the annular groove 211. More specifically, the gasket 400 is filled (substantially) completely with respect to the primary annular groove 211a, and a part of a remaining portion of the gasket is filled into the secondary annular groove 211b (refer to FIG. 3B).

<Advantages of the Sealing Structure According to this Embodiment>

In accordance with the sealing structure according to this embodiment as configured in the above manner, because the gasket 400 is (substantially) completely filled into the primary annular groove 211a, it becomes possible to enhance the sealing performance thereof. In addition, because the secondary annular groove 211b is provided, the part of the gasket 400 filled into the primary annular groove 211a can protrude into the secondary annular groove 211b. For that reason, it is possible to reduce the inserting load at the time of inserting the injector 200 with the gasket 400 fitted thereon into the mounting hole 310. Accordingly, it is possible to reduce the inserting load, while enhancing the sealing performance.

In addition, the gap D2 between the injector 200 and the mounting hole 310 at the boundary section between the primary annular groove 211a and the secondary annular groove 211b is larger than the minute gap D1 at the opposite side of the secondary annular groove 211b intervened by the primary annular groove 211a. Hence, it becomes possible to cause a part of the gasket 400 to protrude to the secondary annular groove 211b side in a more reliable manner.

Moreover, as mentioned above, with respect to the areas S1, S2, S3 shown in FIGS. 2 and 3A, because they are configured to satisfy the relation S1<S3<(S1+S2), the gasket 400 can be filled (substantially) completely into the primary annular groove 211a, while it is possible to suppress the gasket 400 from completely filling the secondary annular groove 211b. Accordingly, it is possible to suppress the gasket 400 from protruding into the outside of the annular groove 211. In addition, along with this, it is also possible to suppress the inserting load.

Further, the secondary annular groove 211b is disposed at the combustion chamber side (C) with respect to the primary annular groove 211a. For that reason, when the injector 200 with the gasket 400 fitted thereon is inserted into the mounting hole 310, frictional resistance against the gasket 400 acts on the opposite side of the combustion chamber (C). Accordingly, the gasket 400 can be filled into the primary annular groove 211a side in a more reliable manner. In addition, a portion of the gasket 400 which has been filled into the secondary annular groove 211b side is subjected to the pressure of a combustion gas, thus the filled state of the gasket 400 with respect to the primary annular groove 211a can be maintained, thereby making it possible to enhance the sealing performance thereof. Here, note that even if the gasket 400 has been deformed due to creep over time, the gasket 400 can stably maintain its filled state with respect to the primary annular groove 211a by receiving the pressure of the combustion gas and the durability thereof can also be improved.

### Second Embodiment

Referring to FIGS. 4A and 4B, a sealing structure according to a second embodiment of the present disclosure will be explained. FIGS. 4A and 4B are schematic cross sectional views of the sealing structure according to the second embodiment of the present disclosure, and correspond to enlarged views of the portion X in FIG. 1. Here, note that FIG. 4A is a view with a gasket 400 omitted, and FIG. 4B is a view with the gasket 400 illustrated.

In this embodiment, an annular groove 212 formed on the outer periphery of an injector 200 has a step in its groove bottom, and is composed of a primary annular groove 212a disposed at one side of this step and a secondary annular groove 212b disposed at the other side thereof. Here, note that the step is such that its diameter becomes larger from an atmospheric air side (A) to a combustion chamber side (C). Similar to the case of the above-mentioned first embodiment, the groove bottom of the primary annular groove 212a is composed of a cylindrical surface. In contrast to this, in this embodiment, the groove bottom of the secondary annular groove 212b is composed of two adjacent tapered surfaces in such a manner that the groove bottom first shrinks thereafter expands in diameter in a direction from the atmospheric air side (A) toward the combustion chamber side (C).

The configuration in which the primary annular groove 212a is disposed at the atmospheric air side (A), and the secondary annular groove 212b is disposed at the combustion chamber side (C) is similar to the above-mentioned first embodiment. In addition, the configuration in which a gap D2 is formed to be larger than a minute gap D1 is also similar to the first embodiment. Here, note that the above-mentioned gap D2 is smaller than a distance between the groove bottom of the primary annular groove 212a and a mounting hole 310. As for the definitions of D1 and D2, their explanations are omitted since they are the same as those explained in the first embodiment. Also, with respect to areas S1, S2 shown in FIG. 4A and the area S3 shown in FIG. 2, they are configured to satisfy the relation S1<S3<(S1+S2), as in the above-mentioned first embodiment. As for the definitions of S1, S2, S3, their explanations are omitted since they are the same as those explained in the first embodiment. Further, as for a method to insert the injector 200, as well as a behavior and a state of the gasket 400 when the injector 200 has been inserted, their explanations are omitted since they are the same as those explained in the first embodiment. Here, note that the gasket 400 is configured such that it can be filled into a portion of the secondary annular groove 212b where its tapered surface shrinks in diameter in a direction from the atmospheric air side (A) toward the combustion chamber side (C) (refer to FIG. 4B).

In the sealing structure according to this embodiment as configured in the above manner, too, the same effects as those in the case of the above-mentioned first embodiment can be obtained. In addition, in the case of this embodiment, the gasket 400 is configured such that it can be filled into the portion of the secondary annular groove 212b where its tapered surface shrinks in diameter in the direction from the atmospheric air side (A) toward the combustion chamber side (C). As a result of this, the area of a portion of the gasket 400 that receives the pressure of the combustion gas can be made larger, as compared to the case of the first embodiment. According to this, a force that the gasket 400 receives in the direction towards the primary annular groove 212a from the pressure of the combustion gas becomes larger as compared to the case of the first embodiment, thus making it possible to maintain the filled state of the gasket 400 with respect to the primary annular groove 212a to a greater extent.

### Third Embodiment

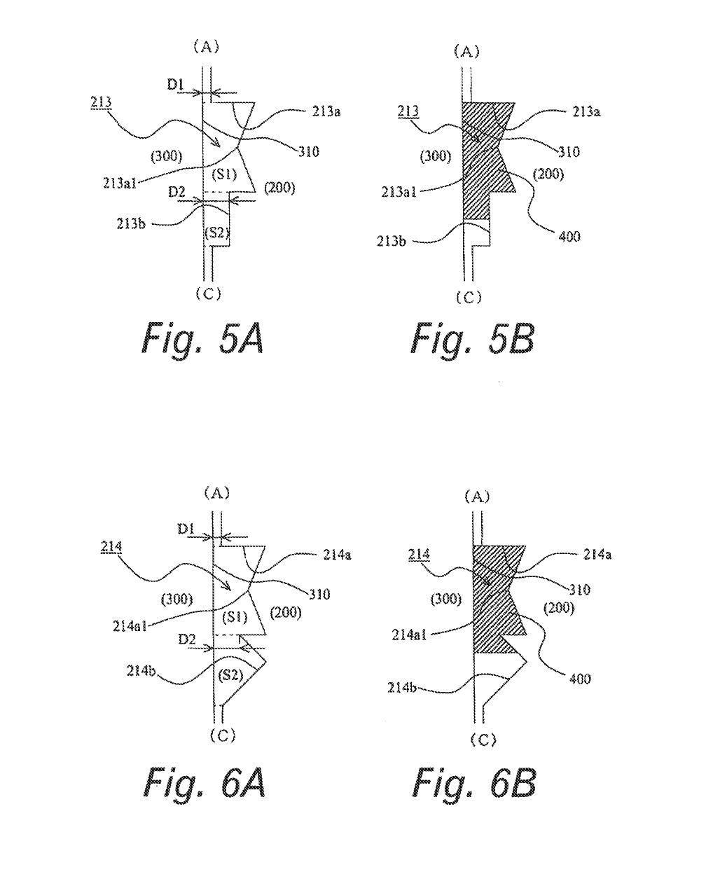

Referring to FIGS. 5A and 5B, a sealing structure according to a third embodiment of the present disclosure will be explained. FIGS. 5A and 5B are schematic cross sectional views of the sealing structure according to the third embodiment of the present disclosure, and correspond to enlarged views of the portion X in FIG. 1. Here, note that FIG. 5A is a view with a gasket 400 omitted, and FIG. 5B is a view with the gasket 400 illustrated.

In this embodiment, an annular groove 213 formed on the outer periphery of an injector 200 has a step in its groove bottom, and is composed of a primary annular groove 213a disposed at one side of this step and a secondary annular groove 213b disposed at the other side thereof. Here, note that the step is such that its diameter becomes larger from an atmospheric air side (A) to a combustion chamber side (C). The groove bottom of the primary annular groove 213a is composed of two adjacent tapered surfaces in such a manner that the groove bottom first expands thereafter shrinks in diameter in a direction from the atmospheric air side (A) toward the combustion chamber side (C). As a result of this, an annular protrusion portion 213a1 is formed on the groove bottom of the primary annular groove 213a in the vicinity of a center in an axial direction thereof. In addition, similar to the case of the above-mentioned first embodiment, the groove bottom of the secondary annular groove 213b is composed of a cylindrical surface.

The configuration in which the primary annular groove 213a is disposed at the atmospheric air side (A), and the secondary annular groove 213b is disposed at the combustion chamber side (C) is similar to the above-mentioned first embodiment. In addition, the configuration in which a gap D2 is formed to be larger than a minute gap D1 is also similar to the first embodiment. Here, note that the above-mentioned gap D2 is smaller than a distance (the smallest distance) between the groove bottom of the primary annular groove 213a and a mounting hole 310. As for the definitions of D1 and D2, their explanations are omitted since they are the same as those explained in the first embodiment. Also, with respect to areas S1, S2 shown in FIG. 5A and the area S3 shown in FIG. 2, they are configured to satisfy the relation S1<S3<(S1+S2), as in the above-mentioned first embodiment. As for the definitions of S1, S2, S3, their explanations are omitted since they are the same as those explained in the first embodiment. Further, as for a method to insert the injector 200, as well as a behavior and a state of the gasket 400 when the injector 200 has been inserted, their explanations are omitted since they are the same as those explained in the first embodiment.

In the sealing structure according to this embodiment as configured in the above manner, too, the same effects as those in the case of the above-mentioned first embodiment can be obtained. In addition, in the case of this embodiment, on the groove bottom of the primary annular groove 213a, the annular protrusion portion 213a1 is formed in the vicinity of the center in the axial direction thereof. As a result of this, the contact pressure of the gasket 400 against the mounting hole 310 can be partially increased, thus making it possible to enhance the sealing performance thereof.

### Fourth Embodiment

Referring to FIGS. 6A and 6B, a sealing structure according to a fourth embodiment of the present disclosure will be explained. FIGS. 6A and 6B are schematic cross sectional views of the sealing structure according to the fourth embodiment of the present disclosure, and correspond to enlarged views of the portion X in FIG. 1. Here, note that FIG. 6A is a view with a gasket 400 omitted, and FIG. 6B is a view with the gasket 400 illustrated.

In this embodiment, an annular groove 214 formed on the outer periphery of an injector 200 has a step in its groove bottom, and is composed of a primary annular groove 214a disposed at one side of this step and a secondary annular groove 214b disposed at the other side thereof. Here, note that the step is such that its diameter becomes larger from an atmospheric air side (A) to a combustion chamber side (C). Similar to the case of the third embodiment, the groove bottom of the primary annular groove 214a is composed of two adjacent tapered surfaces in such a manner that the groove bottom first expands thereafter shrinks in diameter in a direction from the atmospheric air side (A) toward the combustion chamber side (C). In addition, the groove bottom of the secondary annular groove 214b is composed of two adjacent tapered surfaces in such a manner that the groove bottom first shrinks thereafter expands in diameter in a direction from the atmospheric air side (A) toward the combustion chamber side (C).

The configuration in which the primary annular groove 214a is disposed at the atmospheric air side (A), and the secondary annular groove 214b is disposed at the combustion chamber side (C) is similar to the above-mentioned first embodiment. In addition, the configuration in which a gap D2 is formed to be larger than a minute gap D1 is also similar to the first embodiment. Here, note that the above-mentioned gap D2 is smaller than a distance (the smallest distance) between the groove bottom of the primary annular groove 214a and a mounting hole 310. As for the definitions of D1 and D2, their explanations are omitted since they are the same as those explained in the first embodiment. Also, with respect to areas S1, S2 shown in FIG. 6A and the area S3 shown in FIG. 2, they are configured to satisfy the relation S1<S3<(S1+S2), as in the above-mentioned first embodiment. As for the definitions of S1, S2, S3, their explanations are omitted since they are the same as those explained in the first embodiment. Further, as for a method to insert the injector 200, as well as a behavior and a state of the gasket 400 when the injector 200 has been inserted, their explanations are omitted since they are the same as those explained in the first embodiment. Here, note that the gasket 400 is configured such that it can be filled into a portion of the secondary annular groove 214b where its tapered surface shrinks in diameter in a direction from the atmospheric air side (A) toward the combustion chamber side (C) (refer to FIG. 6B).

In the sealing structure according to this embodiment as configured in the above manner, too, the same effects as those in the case of the above-mentioned first embodiment can be obtained. In addition, in the case of this embodiment, the gasket 400 is configured such that it can be filled into the portion of the secondary annular groove 214b where its tapered surface shrinks in diameter in the direction from the atmospheric air side (A) toward the combustion chamber side (C). As a result of this, the area of a portion of the gasket 400 that receives the pressure of the combustion gas can be made larger, as compared to the case of the first embodiment. According to this, a force that the gasket 400 receives in the direction towards the primary annular groove 214a from the pressure of the combustion gas becomes larger as compared to the case of the first embodiment, thus making it possible to maintain the filled state of the gasket 400 with respect to the primary annular groove 214a to a greater extent. Moreover, in the case of this embodiment, on the groove bottom of the primary annular groove 214a, the annular protrusion portion 214a1 is formed in the vicinity of the center in the axial direction thereof. As a result of this, the contact pressure of the gasket 400 against the mounting hole 310 can be partially increased, thus making it possible to enhance the sealing performance thereof.

### Fifth Embodiment

Referring to FIGS. 7A and 7B, a sealing structure according to a fifth embodiment of the present disclosure will be explained. FIGS. 7A and 7B are schematic cross sectional views of the sealing structure according to the fifth embodiment of the present disclosure, and correspond to enlarged views of the portion X in FIG. 1. Here, note that FIG. 7A is a view with a gasket 400 omitted, and FIG. 7B is a view with the gasket 400 illustrated.

In this embodiment, an annular groove 215 formed on the outer periphery of an injector 200 has a step in its groove bottom, and is composed of a primary annular groove 215a disposed at one side of this step and a secondary annular groove 215b disposed at the other side thereof. Here, note that the step is such that its diameter becomes larger from an atmospheric air side (A) to a combustion chamber side (C). The primary annular groove 215a has a groove bottom which is composed of a cylindrical surface as a whole, but an annular protrusion portion 215a1 is formed in the vicinity of a center in an axial direction thereof. In addition, similar to the case of the above-mentioned first embodiment, the groove bottom of the secondary annular groove 215b is composed of a cylindrical surface.

The configuration in which the primary annular groove 215a is disposed at the atmospheric air side (A), and the secondary annular groove 215b is disposed at the combustion chamber side (C) is similar to the above-mentioned first embodiment. In addition, the configuration in which a gap D2 is formed to be larger than a minute gap D1 is also similar to the first embodiment. Here, note that the above-mentioned gap D2 is smaller than a distance (the smallest distance) between the groove bottom of the primary annular groove 215a and a mounting hole 310. As for the definitions of D1 and D2, their explanations are omitted since they are the same as those explained in the first embodiment. Also, with respect to areas S1, S2 shown in FIG. 7A and the area S3 shown in FIG. 2, they are configured to satisfy the relation S1<S3<(S1+S2), as in the above-mentioned first embodiment. As for the definitions of S1, S2, S3, their explanations are omitted since they are the same as those explained in the first embodiment. Further, as for a method to insert the injector 200, as well as a behavior and a state of the gasket 400 when the injector 200 has been inserted, their explanations are omitted since they are the same as those explained in the first embodiment.

In the sealing structure according to this embodiment as configured in the above manner, too, the same effects as those in the case of the above-mentioned first embodiment can be obtained. In addition, in the case of this embodiment, on the groove bottom of the primary annular groove 215a, the annular protrusion portion 215a1 is formed in the vicinity of the center in the axial direction thereof. As a result of this, the contact pressure of the gasket 400 against the mounting hole 310 can be partially increased, thus making it possible to enhance the sealing performance thereof.

### Sixth Embodiment

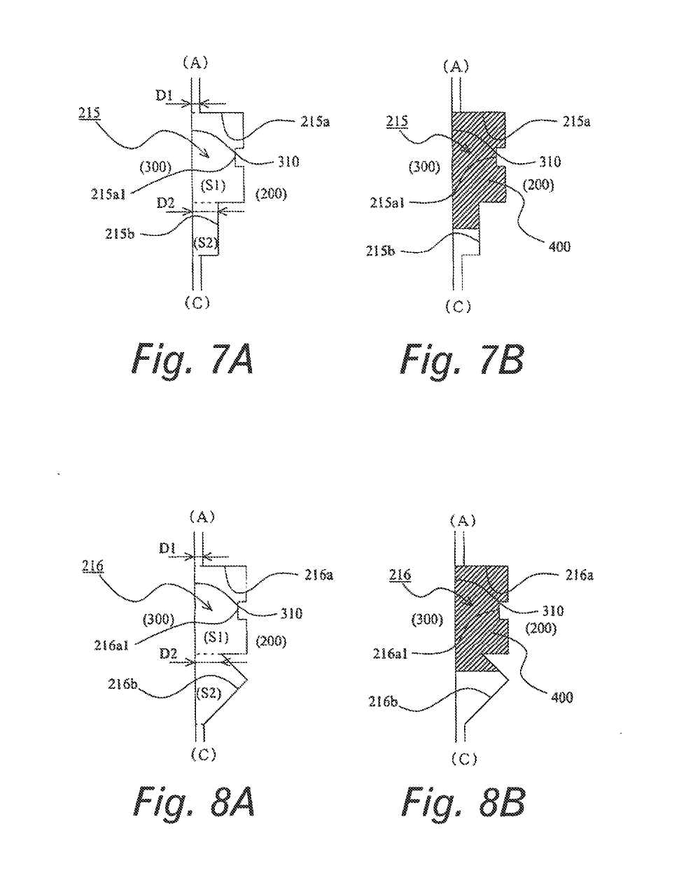

Referring to FIGS. 8A and 8B, a sealing structure according to a sixth embodiment of the present disclosure will be explained. FIGS. 8A and 8B are schematic cross sectional views of the sealing structure according to the sixth embodiment of the present disclosure, and correspond to enlarged views of the portion X in FIG. 1. Here, note that FIG. 8A is a view with a gasket 400 omitted, and FIG. 8B is a view with the gasket 400 illustrated.

In this embodiment, an annular groove 216 formed on the outer periphery of an injector 200 has a step in its groove bottom, and is composed of a primary annular groove 216a disposed at one side of this step and a secondary annular groove 216b disposed at the other side thereof. Here, note that the step is such that its diameter becomes larger from an atmospheric air side (A) to a combustion chamber side (C). The primary annular groove 216a has a groove bottom which is composed of a cylindrical surface as a whole, but an annular protrusion portion 216a1 is formed in the vicinity of a center in an axial direction thereof. In addition, the groove bottom of the secondary annular groove 216b is composed of two adjacent tapered surfaces in such a manner that the groove bottom first shrinks thereafter expands in diameter in a direction from the atmospheric air side (A) toward the combustion chamber side (C).

The configuration in which the primary annular groove 216a is disposed at the atmospheric air side (A), and the secondary annular groove 216b is disposed at the combustion chamber side (C) is similar to the above-mentioned first embodiment. In addition, the configuration in which a gap D2 is formed to be larger than a minute gap D1 is also similar to the first embodiment. Here, note that the above-mentioned gap D2 is smaller than a distance (the smallest distance) between the groove bottom of the primary annular groove 216a and a mounting hole 310. As for the definitions of D1 and D2, their explanations are omitted since they are the same as those explained in the first embodiment. Also, with respect to areas S1, S2 shown in FIG. 8A and the area S3 shown in FIG. 2, they are configured to satisfy the relation S1<S3<(S1+S2), as in the above-mentioned first embodiment. As for the definitions of S1, S2, S3, their explanations are omitted since they are the same as those explained in the first embodiment. Further, as for a method to insert the injector 200, as well as a behavior and a state of the gasket 400 when the injector 200 has been inserted, their explanations are omitted since they are the same as those explained in the first embodiment. Here, note that the gasket 400 is configured such that it can be filled into a portion of the secondary annular groove 216b where its tapered surface shrinks in diameter in a direction from the atmospheric air side (A) toward the combustion chamber side (C) (refer to FIG. 8B).

In the sealing structure according to this embodiment as configured in the above manner, too, the same effects as those in the case of the above-mentioned first embodiment can be obtained. In addition, in the case of this embodiment, the gasket 400 is configured such that it can be filled into the portion of the secondary annular groove 216b where its tapered surface shrinks in diameter in the direction from the atmospheric air side (A) toward the combustion chamber side (C). As a result of this, the area of a portion of the gasket 400 that receives the pressure of the combustion gas can be made larger, as compared to the case of the first embodiment. According to this, a force that the gasket 400 receives in the direction towards the primary annular groove 216a from the pressure of the combustion gas becomes larger as compared to the case of the first embodiment, thus making it possible to maintain the filled state of the gasket 400 with respect to the primary annular groove 216a to a greater extent. Moreover, in the case of this embodiment, on the groove bottom of the primary annular groove 216a, the annular protrusion portion 216a1 is formed in the vicinity of the center in the axial direction thereof. As a result of this, the contact pressure of the gasket 400 against the mounting hole 310 can be partially increased, thus making it possible to enhance the sealing performance thereof.

### EXPLANATION OF REFERENCE NUMERALS AND CHARACTERS

100 sealing device
200 injector
210, 211, 212, 213, 214, 215, 216 annular groove
211a, 212a, 213a, 214a, 215a, 216a primary annular groove
211b, 212b, 213b, 214b, 215b, 216b secondary annular groove
213a1, 214a1, 215a1, 216a1 protrusion portion
300 housing
310 mounting hole
400 gasket

1. A sealing structure comprising:
an injector;
a housing having a mounting hole in which the injector is mounted; and
an annular gasket being fitted in an annular groove formed in an outer periphery of the injector to seal an annular gap between the injector and the mounting hole;
wherein the annular groove has a step on its groove bottom;
the annular groove comprises:
a primary annular groove disposed at one side of the step; and
a secondary annular groove disposed at another side of the step;
the gasket is disposed so that it is filled into the primary annular groove; and
a gap between the injector and the mounting hole at a boundary section between the primary annular groove and the secondary annular groove is larger than a minute gap at an opposite side of the secondary annular groove intervened by the primary annular groove.

2. The sealing structure as set forth in claim 1, wherein the following relation is satisfied:
S1<S3<(S1+S2).
where S1 is an area of a cross section of an annular space formed by the primary annular groove and a surface of the mounting hole intersected by a plane including an axis of the annular space, S2 is an area of a cross section of an annular space formed by the secondary annular groove and the surface of the mounting hole intersected by a plane including an axis of the annular space, S3 is an area of a cross section of the gasket intersected by a plane including an axis of the gasket when the gasket is in a state of not being subjected to any external force.

3. The sealing structure as set forth in claim 1, wherein the secondary annular groove is disposed at a combustion chamber side with respect to the primary annular groove.

4. The sealing structure as set forth in claim 1, wherein a shape of the cross section of the gasket intersected by the plane including the axis of the gasket when the gasket is in a state of not being subjected to any external force is rectangular.

5. The sealing structure as set forth in claim 4, wherein the primary annular groove has an annular protrusion portion formed on its groove bottom in a vicinity of a center in an axial direction thereof.

6. The sealing structure as set forth in claim 2, wherein the secondary annular groove is disposed at a combustion chamber side with respect to the primary annular groove.

7. The sealing structure as set forth in claim 2, wherein a shape of the cross section of the gasket intersected by the plane including the axis of the gasket when the gasket is in a state of not being subjected to any external force is rectangular.

8. The sealing structure as set forth in claim 3, wherein a shape of the cross section of the gasket intersected by the plane including the axis of the gasket when the gasket is in a state of not being subjected to any external force is rectangular.

9. The sealing structure as set forth in claim 6, wherein a shape of the cross section of the gasket intersected by the plane including the axis of the gasket when the gasket is in a state of not being subjected to any external force is rectangular.

10. The sealing structure as set forth in claim 7, wherein the primary annular groove has an annular protrusion portion formed on its groove bottom in a vicinity of a center in an axial direction thereof.

11. The sealing structure as set forth in claim 8, wherein the primary annular groove has an annular protrusion portion formed on its groove bottom in a vicinity of a center in an axial direction thereof.

12. The sealing structure as set forth in claim 9, wherein the primary annular groove has an annular protrusion portion formed on its groove bottom in a vicinity of a center in an axial direction thereof.
